(19) United States
(12) Patent Application Publication
(10) Pub. No.: US 2026/0177729 A1
(43) Pub. Date: Jun. 25, 2026

(54) OPTICAL FILTER AND METHOD OF MANUFACTURING AN OPTICAL FILTER

(71) Applicant: Fieldpoint (Cyprus) Limited, Nicosia (CY)

(72) Inventor: Noel Thompson, Belgrade (RS)

(21) Appl. No.: 19/129,136

(22) PCT Filed: Feb. 15, 2023
(86) PCT No.: PCT/EP2023/053737

§ 371 Date: May 12, 2025

(51) Int. Cl. G02B 5/20; B82Y 20/00; B82Y 40/00; G02B 5/28

(52) U.S. Cl. CPC G02B 5/206; B82Y 20/00; B82Y 40/00; G02B 5/283

(57) ABSTRACT

An optical filter comprises: a matrix including an optically transparent matrix material, and nanoparticles embedded in the matrix material, the nanoparticles comprising carbon atoms arranged in a hexagonal structure, wherein at least one of the nanoparticles is physically separated from any other of the nanoparticles and/or at least one nanoparticle aggregate including a plurality of the nanoparticles has a maximum diameter of less than 30 nm, each of the nanoparticles of the at least one nanoparticle aggregate being in physical contact with at least another one of the nanoparticles of the at least one nanoparticle aggregate.

### TECHNICAL FIELD

Various embodiments relate generally to optical filters and methods of manufacturing optical filters.

### BACKGROUND

Radiation from the sun hits the Earth in the wavelength range of 100 nm to 1 million nm, including ultraviolet rays, visible light, and infrared rays. These three neighbouring components of the electromagnetic spectrum are generally defined as wavelengths in the range between 150 nm to 3 μm. Artificial light from electronic sources such as light bulbs, LEDs or computer and phone screens is particularly rich in light of wavelengths below 500 nm.

Some portions of this spectrum, especially those that fall below 500 nm, are known to be harmful to the structures of the human eye, and have been linked to secondary health effects via the triggering of various neural pathways and systems in the brain through the optic nerve. It is desirable to eliminate or minimize this light, which will henceforth be referred to as “high-energy blue light” or “undesirable wavelengths”.

A large variety of filters already exist that provide protection from high-energy blue light, whether in the form of eyeglasses, screen protectors, lightbulb covers or some other form. These filters are transparent in the visible wavelength range of the electromagnetic spectrum, and are placed between the source of the high-energy blue light and the human eye. The majority of these filters simply absorb the undesirable wavelengths, which also results in alteration the viewed image, whether as distortion, dimming or a change in colour.

Furthermore, many optically transparent materials that provide shielding against harmful portions of the electromagnetic spectrum are principally inorganic in nature and are formed of glasses or minerals which may be enriched with various shielding elements. Whilst these might have desirable optical properties, they have undesirable physical and mechanical properties, being typically heavy, brittle and fragile. High refractive index polymeric and resin materials have desirable optical and mechanical properties, being clear, strong and lightweight, but lack protective properties against undesirable wavelengths.

The interaction of electromagnetic radiation, especially visible light, with carbon-based nanomaterials exhibiting complex structural and dielectric properties has been demonstrated to alter the composition of the incident light beam (see, e.g. US 2008/286453 A1, WO 2017/211420 A1, U.S. Pat. No. 6,066,272 A, US 2011/001252 A1, WO 2020/249207 A1).

Carbon-based nanomaterials are either deposited in the form of thin coatings on a filter carrier or incorporated into an optically transparent matrix to avoid an easy abrasion. Incorporating the nanomaterials into a transparent polymeric or resin matrix is, however, very difficult due to the very limited solubility of the carbon-based nanomaterials in a matrix of common polymeric or resin materials which makes the mixing and dispersing the carbon-based nanomaterials in desired concentrations into any matrix material very difficult. Further problems arise with achieving homogenous dispersions free of visible clusters or aberrations within optical materials, which is desirable from an optical perspective.

There is therefore a need for nanoparticles containing optical filters with excellent optical properties, and a method of manufacturing such optical filters.

### SUMMARY

According to a first aspect of the present disclosure, an optical filter is provided, comprising a matrix including an optically transparent matrix material, and nanoparticles embedded in the matrix material. The nanoparticles include carbon atoms arranged in a hexagonal or mixed hexagonal and pentagonal structure.

At least one of the nanoparticles is physically separated from any other of the nanoparticles, i.e. the at least one nanoparticle is in exclusive contact with the matrix material, but not with another one of the nanoparticles. The existence of such a nanoparticle is an indicator of the homogeneous distribution of the nanoparticles within the matrix material which contributes to reducing or even eliminating the aforementioned undesirable distortions, dimming, or color change as compared to commercially available materials. That is, optical filters according to the present disclosure are configured to reduce or eliminate the aforementioned undesirable wavelengths with far less distortions, dimming, or color change than commercially available materials.

In an exemplary embodiment, a plurality of the nanoparticles or most of the nanoparticles are respectively physically separated from any other of the nanoparticles.

Alternatively or additionally, at least one nanoparticle aggregate including a plurality of the nanoparticles has a maximum diameter of less than 30 nm, each of the nanoparticles of the at least one nanoparticle aggregate being in physical contact with at least another one of the nanoparticles of the at least one nanoparticle aggregate. The existence of such aggregates is a further indicator of a homogeneous distribution of the nanoparticles within the matrix material which contributes to reducing or even eliminating the aforementioned undesirable distortions, dimming, or color change as compared to commercially available materials. That is, optical filters according to the present disclosure are configured to reduce or eliminate the aforementioned undesirable wavelengths with far less distortions, dimming, or color change than commercially available materials.

Optionally, most of the nanoparticle aggregates have a maximum diameter of less than 30 nm.

Suitable entities for the characterization of the optical quality of an optical filter according to the present disclosure are the maximum variation of refractive index and/or the maximum density of striae causing an optical path difference of 30 nm. These criteria are also used in ISO Standard 10110.

An optical filter according to an exemplary embodiment of the present disclosure may cause a maximum variation of refractive index of ±50·10⁻⁶ and/or may have a maximum density of striae causing an optical path difference of 30 nm of 10%.

The above-defined maximum variation of refractive index defines the optical inhomogeneity according to Standard ISO 10110-4. A maximum variation of refractive index of ±50·10⁻⁶ as defined above corresponds to Homogeneity Class 0 according to Standard ISO 10110-4. An optical filter according to an exemplary embodiment may cause a maximum variation of refractive index of ±20·10⁻⁶ (Homogeneity Class 1 according to Standard ISO 10110-4), optionally a maximum variation of refractive index of ±5·10⁻⁶ (Homogeneity Class 2 according to Standard ISO 10110-4), further optionally a maximum variation of refractive index of ±2·10⁻⁶ (Homogeneity Class 3 according to Standard ISO 10110-4), further optionally a maximum variation of refractive index of ±1·10⁻⁶ (Homogeneity Class 4 according to Standard ISO 10110-4), further optionally a maximum variation of refractive index of ±0.5·10⁻⁶ (Homogeneity Class 5 according to Standard ISO 10110-4).

The above-defined maximum density of striae causing an optical path difference of 30 nm of 10% corresponds to Striae Class 1 according to Standard ISO 10110-4. An optical filter according to an exemplary embodiment may have a maximum density of striae causing an optical path difference of 30 nm of 5% (Striae Class 2 according to Standard ISO 10110-4), optionally a maximum density of striae causing an optical path difference of 30 nm of 2% (Striae Class 3 according to Standard ISO 10110-4), further optionally a maximum density of striae causing an optical path difference of 30 nm of 1% (Striae Class 4 according to Standard ISO 10110-4), further optionally no visible striae (Striae Class 5 according to Standard ISO 10110-4).

A commonly used technique of determining the homogeneity and striae classes is the shadowgraph technique which allows a quantitative assessment of the homogeneity and striae classes by means of a caliper and a reference filter. Alternatively, the homogeneity and striae classes can be determined by means of an interferometer. These techniques are well-known to a skilled person.

Alternatively or additionally, the optical filter may be characterized according to one or more of the following standards: ANSI Z80.1, ANSI Z80.3, ISO 8980-1. An optical filter according to an exemplary embodiment of the present disclosure would be capable of satisfying the lens quality and clarity requirements specified in the aforementioned standards.

The nanoparticles may be of diameters (e.g. average diameters corresponding to an arithmetic mean) between 1 nm and 1000 nm. The nanoparticles may be of uniform or random size distribution. The nanoparticles and/or their aggregates may be spherical or rod-shaped, with or without regular or crystalline structure. Depending upon the compositions of both the nanoparticles and the matrix material they may constitute between 0.0005 wt % and 15 wt %, optionally between 0.01 wt % and 5 wt % of the entire mass (weight) of the optical filter.

The light filtering or altering effect of an optical filter according to the present disclosure, in particular in the wavelength range between 200-600 nm, increases with increasing nanoparticle concentration.

The nanoparticles may include one or both of graphene nanoparticles and carbon nanotubes. Graphene nanoparticles may include or may be fragments of a graphene layer. The graphene nanoparticles may exist as single, straight sheets, or in a multi-layered or otherwise entangled or wrinkled arrangement. The carbon nanotubes may exist as single-walled or multi-walled nanotubes. The carbon nanotubes may have dimensions (e.g. lengths) between 10 nm and 20 μm, optionally between 20 nm and 5 μm.

The nanoparticles may include nanoparticles including carbon atoms arranged in a pentagonal structure. Nanoparticles of this type can be said to have a mixed hexagonal and pentagonal structure. Such nanoparticles may include or may be configured as fullerenes. The fullerenes may be individual molecules between 1 nm and 10 nm, optionally between 1 nm and 2 nm, in diameter (e.g. average diameters corresponding to an arithmetic mean). The fullerenes may include or may be configured as C₆₀ fullerenes (Buckminster fullerenes) or as higher molecular weight fullerenes such as C₇₀, C₈₄, etc. C₆₀ is composed of 60 carbon atoms ordered in 12 pentagons and 20 hexagons and defining a carbon complex structure (carbon cage).

The nanoparticles within any given optical filter may be of the same type or may be mixtures of different types. In an optical filter according to the present disclosure, smaller fullerenes such as C₆₀ and C₇₀ and/or their derivatives may constitute between 25 wt % and 100 wt %, optionally between 50 wt % and 95 wt %, of the nanoparticles' total mass (weight).

The fullerenes may include or may be configured as endohedral fullerenes. Endohedral fullerenes are fullerenes that have one or more additional particles (e.g. atoms, ions, molecules) enclosed within the carbon cage. The particles enclosed within the carbon cage are referred to as dopants.

Encasing particles within a fullerene carbon cage is an effective means of combining otherwise incompatible materials within a single optical filter (i.e. materials that may react, disrupt or interfere with one another chemically, optically or mechanically when in direct contact or mixture with one another) as encasement within the fullerene carbon cage prevents the enclosed particles from interacting with one another, and can protect the matrix material from interacting with the enclosed particles that might have good optical properties but degradative chemical or mechanical properties on the matrix material. In contrast to “incompatible materials” “compatible materials” can coexist within the same matrix material and concurrently exhibit their own optical or light-altering effects without negatively affecting one another.

The endohedral fullerenes may contain within their carbon complex structure, i.e. carbon cage, one or more of metal dopants, semimetal dopants, or their respective oxides, chlorides, fluorides, iodides, or nitrates. Exemplary dopants include one or more of: aluminum, antimony, barium, cerium, copper, didymium, gold, iron, lead, magnesium, molybdenum, neodymium, nickel, niobium, palladium, platinum, potassium, praseodymium, silicon, silver, tin, titanium, tungsten, vanadium, zinc and zirconium, as well as their respective oxides, chlorides, fluorides, iodides and nitrates.

An effective combination of incompatible particles can be ensured by a mass fraction of the endohedral fullerenes relative to the total mass of the nanoparticles of 0 to 70%, optionally 20 to 60%, further optionally 30 to 50%.

One or more of the nanoparticles may include one or more functional groups. Nanoparticles including one or more functional groups will be referred to as functionalized nanoparticles. The one or more functional groups may contain elements other than carbon. The functional groups may enhance or alter the interaction of the nanoparticles with light, or may facilitate superior bonding, dissolution or interaction of the nanoparticles with the matrix material into which they are incorporated.

The one or more functional groups may be or may include one or more of: amide, amine, carbonyl, carboxyl, epoxide, ester, halide, hydroxyl, isocyanate, isothiocyanate, thiol, and sulfur containing groups, e.g. sulphate, sulfone, sulphide groups etc.

The functionalized nanoparticles are functionalized derivatives of the nanoparticles. The functionalized derivatives within any given optical filter may all contain one or more of the aforementioned functional groups, or there may be a mixture of nanoparticles and their functionalized derivatives with and without the aforementioned functional groups, with the same or different numbers of functional groups. The aforementioned functional groups may be of the same type or may be of different types, e.g. mixtures of different compounds.

The matrix material may include one or more of: an acrylate-based polymer, a polycarbonate-based polymer, a urethane-based polymer, a thiourethane-based polymer, an epoxy-based polymer, and an episulphide-based polymer. In an exemplary embodiment, a matrix material may include polymers exhibiting aromatic structure.

The matrix material may comprise a single material type, or may comprise two or more material types, either copolymerized together or simply mixed. In the case where two or more materials are combined in a single optical filter, it is particularly preferred that they be thoroughly mixed so as to give a homogenous final structure to ensure optical and structural consistency across the optical filter.

The matrix material may include an inorganic material, optionally an inorganic glass or a mineral material (e.g. a synthetic or natural crystalline inorganic material). A mass fraction of the inorganic material relative to the entire mass of the matrix material may be at least 50 wt %, optionally at least 80 wt %, further optionally at least 95 wt %.

According to a second aspect of the present disclosure, a multilayer optical filter is provided, comprising a plurality of filter layers stacked in a thickness direction of the multilayer optical filter, wherein one or more filter layers of the plurality of filter layers are configured as an optical filter described above.

A multilayer optical filter described above may be of particular interest when using a plurality of incompatible materials. By separating incompatible materials into separate filter layers their benefits can be harnessed without the consequences of their incompatibility.

The number of filter layers may range between 2 and 20, optionally between 2 and 10, further optionally between 2 and 5.

The multilayer optical filter as a whole may cause a maximum variation of refractive index of ±50·10⁻⁶, optionally of ±20·10⁻⁶, further optionally of ±5·10⁻⁶, further optionally of ±2·10⁻⁶, further optionally of ±1·10⁻⁶, further optionally of 0.5·10⁻⁶. Additionally or alternatively, the multilayer optical filter as a whole may have a maximum density of striae causing an optical path difference of 30 nm of 10%, optionally may have a maximum density of striae causing an optical path difference of 30 nm of 5%, further optionally may have a maximum density of striae causing an optical path difference of 30 nm of 2%, further optionally may have a maximum density of striae causing an optical path difference of 30 nm of 1%, further optionally may have no visible striae.

The plurality of filter layers may include first and second filter layers configured as optical filters described above with mutually different nanoparticle compositions or with mutually different matrix materials or with mutually different nanoparticle compositions and mutually different matrix materials. This configuration offers an effective way of incorporating incompatible matrix materials and/or nanoparticles into a single filter.

The filter layers may be of the same thickness or may be of different thicknesses depending of the filter characteristics of the filter, since the transmission of a given filter layer decreases with increasing filter layer thickness.

The filter layers may have the same refractive power (dioptre) or may be of different refractive powers depending upon desired mechanical and optical characteristics. By adjusting the refractive power of the individual filter layers, the overall thickness and dioptre of the multilayer optical filter may be optimized, e.g. minimized or reduced. The thicknesses of the different filter layers, as well as the ratios of the thicknesses of the different filter layers, may be different in different areas of the filter.

In an exemplary multilayer filter, at least one filter layer of the plurality of filter layers may be free of nanoparticles comprising carbon atoms arranged in a hexagonal structure (e.g., a hexagonal and pentagonal structure). Such a filter layer may effectively separate two adjacent filter layers including nanoparticles and/or matrix materials which are mutually incompatible.

The at least one filter layer that is free of nanoparticles comprising carbon atoms arranged in a hexagonal structure may include an inorganic material, optionally an inorganic glass or mineral material with a mass fraction relative to the total mass of the at least one filter layer of at least 50 wt %, optionally at least 80 wt %, further optionally at least 95 wt %.

The mineral or inorganic glass containing filter layer is preferably sandwiched in the thickness direction of the multilayer filter between two polymer or resin layers which act as protection layers for the inorganic glass or mineral containing layer.

In an exemplary multilayer filter including a plurality of mineral or inorganic glass containing filter layers, at least two of the plurality of these layers are separated by at least one polymer or resin layer to prevent glass-on-glass contact and abrasion and/or fracture.

The mineral or inorganic glass may be enriched with a metal or semimetal, or its respective oxide for enhancing its optical or mechanical properties. Although there is no particular limitation, the most preferable metals and semimetals include one or more of: aluminium, barium, boron, calcium, cerium, didymium, gold, lead, magnesium, neodymium, niobium, platinum, potassium, praseodymium, silver, sodium, strontium, tin, titanium and zirconium, as well as their respective oxides. The at least one filter layer that is free of nanoparticles comprising carbon atoms arranged in a hexagonal structure may contain a single enriching compound, or may contain multiple enriching compounds to harness the enhancing properties of multiple compounds within a single layer. In the case of optical filters comprising a plurality of inorganic glass or mineral containing filter layers that are free of nanoparticles comprising carbon atoms arranged in a hexagonal structure, the layers may comprise the same inorganic glass or mineral, or different inorganic glasses or minerals, mixtures or combinations thereof, so as to harness the optical qualities of multiple different materials within a single optical filter. These layers may contain the same enriching compound or combination of enriching compounds, or may contain different enriching compounds or combinations therein. A given glass or mineral filter layer may contain one or more enriching agents. The enriching agent or agents may constitute between 0.5 wt % to 70 wt %, preferably 5 wt % and 40 wt %, of the entire mass of the respective inorganic glass or mineral containing filter layer.

In an exemplary multilayer filter, at least two filter layers of the plurality of filter layers may have substantially the same dimensions and/or shapes in a direction orthogonal to the thickness direction. Optionally, most of the filter layers or even all of the plurality of filter layers may have substantially the same dimensions and/or shapes in a direction orthogonal to the thickness direction. In such a multilayer filter, a light beam passes through a substantially equal number of filter layers independent of the incident angle and location on the filter and offers, hence, a consistent image across the multilayer filter. Such a configuration is particularly suitable for multilayer filters configured as plano or single-dioptre lenses.

In an exemplary multilayer filter, at least two filter layers of the plurality of filter layers, optionally most of or even all of the filter layers of the plurality of filter layers, may have mutually different dimensions or mutually different shapes or mutually different dimensions and shapes in a direction orthogonal to the thickness direction. In such a multilayer filter, a light beam passes through a variable number of filter layers depending on the incident angle and location on the filter. Such a configuration is particularly suitable for progressive ophthalmic lenses or light filters for medical or technical uses, as the dioptre and/or intensity of transmitted light will be different in different parts of the filter.

The above-described optical filters or multilayer filters may be used as a protective screen on top of or incorporated into the screen of an electronic device (such as televisions, mobile phones etc.). Alternatively, these filters may be used in eyeglasses or sunglasses, or may be used as lenses for technical applications (such as in cameras, binoculars, telescopes etc.). These filters may have refractive power or not.

The optical filters and/or the filter layers described above may further include other particles that confer certain unique optical properties, e.g. altering the refractive index. These other particles may comprise metals or semimetals or their respective oxides, chlorides, fluorides, iodides or nitrates. Although there is no particular limitation, the most preferable metals and semimetals are aluminium, antimony, barium, cerium, copper, didymium (mixture of praseodymium and neodymium), gold, iron, lead, magnesium, molybdenum, neodymium, nickel, niobium, palladium, platinum, potassium, praseodymium, silicon, silver, tin, titanium, tungsten, vanadium, zinc and zirconium, as well as their oxides, chlorides, fluorides, iodides and nitrates. These other particles may all be of the same type, i.e. the same material, or may be a mixture of different types, i.e. different materials. These other particles may have an average diameter (e.g. corresponding to an arithmetic mean) between 2 nm and 5 μm, preferably between 5 nm and 3 μm. They may all be of the same diameter, or may be of different diameters. In the present invention these other particles comprising one or more of the aforementioned compounds may constitute between 0 wt % and 80 wt %, preferably between 5 wt % and 50 wt %, of the nanoparticles' total mass.

The optical filters and/or the filter layers described above may further include one or more additional components (e.g. additives), such as dyes (which may or may not have their own light filtering effect), ultraviolet inhibitors, mold release agents etc. Such additional components may also be added to filter layers that do not contain the nanoparticles comprising carbon atoms arranged in a hexagonal structure. They may be dissolved in the matrix material to a molecular level, and may be partially-dissolved or fully-dissolved. Alternatively, the nanoparticles and/or the other particles may exist in the matrix as clusters or aggregates, depending on their composition, method of introduction into the matrix material and desired optical qualities. Individual clusters or aggregates may be homogenous or may be mixtures of different nanoparticle/particle types. These clusters or aggregates may exhibit regular, ordered structure or irregular, random structure and may be spherical, rod-shaped, amorphous or crystalline, depending on their composition, method of preparation and desired optical qualities. Within a given optical filter or filter layer some of the nanoparticles and/or of the other particles may exist as individual nanoparticles/particles and some may exist concurrently as clusters or aggregates.

The other particles may be dispersed in the matrix to a degree such that individual particles are exclusively surrounded by and in contact with the matrix material.

The filter, as a whole object, may further include an outer coating. Although there is no particular limitation, the most preferable coatings are hard protective coatings or other coloring, anti-reflective, anti-ultraviolet or anti-polarization coatings, as is well known in the art. In the case of multilayer filters, the filter layers may be separated by a thin coating, film or adhesive, or may be directly layered on top of one another, depending on the desired mechanical and optical properties.

According to a third aspect of the present disclosure, a method of manufacturing an optical filter is provided. The method includes: adding nanoparticles comprising carbon atoms arranged in a hexagonal or mixed hexagonal and pentagonal structure to an optically transparent matrix material or to a precursor of an optically transparent matrix material to obtain a mixture; homogenizing the mixture to obtain a homogenized mixture (e.g. dispersion); and inserting the homogenized mixture into a mold to form the optical filter. This method may be carried out in the above-described order. Any of the above-described nanoparticles and/or matrix materials may be used for manufacturing an optical filter by means of this method.

The homogenizing the mixture overcomes the nanoparticles' extremely limited solubility and problems with excessive or uncontrolled clustering or aggregations, which result in low-quality, unclear lenses. The above method thus enables the manufacturing of optical filters and multilayer filters with the above-described properties, i.e. the optical filters according to the present disclosure can be manufactured by means of the above method.

The nanoparticles extremely limited solubility necessitates their dispersion within the matrix material or precursor material as a colloidal suspension rather than as a solution, which in turn necessitates dispersion and homogenization in place of dissolution. Where dissolution of the nanoparticles is possible or required, their solubility with respect to the optically transparent matrix material or to the precursor of an optically transparent matrix material must be determined. Where colloidal dispersions of nanoparticles within the optically transparent matrix material or to the precursor of an optically transparent matrix material are desired or necessitated with only partial or no dissolution, a critical factor is the rate at which the nanoparticles sediment or float, determined by the following equation, which assumes that the nanoparticles are spherical:

$${Υ}_{s} = \frac{V ( {ρ}_{p} - {ρ}_{m} ) g}{6 π η r}$$

Here, Yₛ is the nanoparticle sedimentation or flotation velocity, V is the nanoparticle volume, ρₚ is the nanoparticle density, ρₘ is the density of the optically transparent matrix material or the precursor of an optically transparent matrix material, g is the gravitational acceleration, η is the viscosity of the optically transparent matrix material or the precursor of an optically transparent matrix material and r is the nanoparticle radius.

The size of the nanoparticles and the difference in density between the nanoparticles and the optically transparent matrix material or the precursor of an optically transparent matrix material determine the rate at which the nanoparticles will float or sink, with smaller particles generally sinking or floating more slowly than their larger counterparts. Sedimentation or flotation velocity is inversely proportional to the viscosity of the optically transparent matrix material or the precursor of an optically transparent matrix material. When balanced against the time that the mixture must stand prior to curing, as well as the curing time and the increase in viscosity induced by the setting or curing of the optically transparent matrix material or the precursor of an optically transparent matrix material, the most appropriate nanoparticle or nanoparticle aggregate diameter can be determined, and the most appropriate point in the filter preparation process can be selected for the introduction of the nanoparticles. In the case where multiple matrix materials are used, the most appropriate individual or combination of these can be selected as the one in which to disperse the nanoparticles.

Without wishing to be bound by any particular theory, the dispersibilities of nanoparticles and their final diameters in colloidal suspensions are heavily influenced by the ability of the fluid to mechanically break up and disperse the nanoparticle material using shear force:

$$τ = {ηΥ}_{m}$$

Here, τ is the shear force upon the nanomaterial during mixing, η is the viscosity of the optically transparent matrix material or the precursor of an optically transparent matrix material and Yₘ is the velocity of the optically transparent matrix material or the precursor of an optically transparent matrix material during mixing. The efficacy of any such mixing and dispersing process is further dictated by the rate of liquid shear:

$${R}_{s} = \frac{{V}_{u}}{{D}_{s}}$$

Here, Rₛ is the shear rate, Vᵤ is the tip speed of the rotor (the spinning unit that mixes the liquid, with Vᵤ itself determined by the rotor's diameter and its number of revolutions per minute), and Dₛ is the distance between the rotor and the stator (the housing around the rotor). This allows for the obtaining of a high shear rate without being constrained by any one single dimension of the apparatus required to achieve it. A high liquid shear force, liquid velocity and shear rate are required to obtain particularly fine nanoparticles and, thus, stable suspensions of nanoparticles within the optically transparent matrix material or the precursor of an optically transparent matrix material. This process can be assisted through the selection of high viscosities of the optically transparent matrix material or the precursor of an optically transparent matrix material.

The homogenizing the mixture may include: a high-speed homogenization at mixing speeds above 5000 rpm (rotations per minute), optionally above 10000 rpm, further optionally between 10000 rpm and 80000 rpm, and/or a sonication at frequencies above 5 kHz, optionally above 10 kHz, further optionally between 10 KHz and 80 KHz. Such a homogenizing of the mixture leads to a colloidal suspension which effectively overcomes the problem of the nanoparticles' extremely limited solubility in commonly used matrix materials or precursors of commonly used matrix materials.

The homogenizing the mixture may involve mixing with shear rates above 30000 s⁻¹, optionally above 50000 s⁻¹, further optionally between 60000 s⁻¹ and 350000 s⁻¹. Mixing with these shear rates contributes to highly homogeneous distribution of the nanoparticles within the mixture.

The homogenizing can be carried out at temperatures above room temperature and below the melting, boiling, or decomposition temperature of the matrix material or precursor of the matrix material. Alternatively, in case the nanoparticles are added to a precursor of the matrix material, the homogenizing can be carried out at temperatures below room temperature to control the stability and increase the viscosity of the precursor which improves the shearing ability of the precursor.

The mixing may be performed under a vacuum, e.g. at a pressure below 0.1 bar, optionally below 0.01 bar, further optionally below 0.001 bar, to prevent the mixing and dissolution of gases into the mixture, as the presence of gas or bubbles in the material can produce an optically inferior filter. The mixing may be performed under an inert gaseous atmosphere to prevent reaction or oxidation of either the matrix or precursor material or the nanoparticles or additives, which can compromise the filter's optical or mechanical properties. The nanoparticles may be mixed with or added alongside other additives to the filters such as antioxidants, UV stabilizers, dyes and mold-release agents. In cases where multiple types of nanoparticles are added, they may be added at the same time or at different stages in the mixing process depending upon the desired degrees of homogenization for the different nanoparticle types.

During the adding the nanoparticles to the optically transparent matrix material or to the precursor of an optically transparent matrix material the optically transparent matrix material or the precursor of an optically transparent matrix material may be in a liquid state to obtain a liquid mixture and/or during the homogenizing the mixture the mixture may be in a liquid state. By means of these measures, the degree of homogeneity can be further increased. Alternatively, in the case where a thermoplastic is used for or as the matrix material, the nanoparticles may be added to the granular or powdered thermoplastic prior to melting.

The degree of homogeneity can be further increased by adding a surfactant to the liquid mixture or the homogenized mixture. The use of a surfactant may be of particular importance in case where homogenous dispersion of the nanoparticles is desired, or a protective layer around the nanoparticles is desired to prevent their direct interaction with the matrix material of the precursor material. This surfactant may be added before, at the same time as or after the nanoparticles, depending upon the type of nanoparticles and their interactions with the surfactant and matrix or precursor material, as well as the manufacturing process employed. In instances where high-speed homogenization is utilized the surfactant is most preferably added after homogenization to avoid the generation of excess foam. One or more surfactants may be used, which may be added concurrently or during different phases (e.g. process or method steps) in the production procedure.

A mass ratio of surfactant to nanoparticles may be in the range of 1:1 to 50:1, optionally of 10:1 to 35:1. Suitable surfactants are surfactants selected from the group consisting of non-ionic surfactants, anionic surfactants, cationic surfactants, and amphoteric surfactants, or mixtures thereof. Although there is no particular limitation, the most preferable surfactants include one or more of dodecyl trimethyl ammonium chloride, myristyl trimethyl ammonium bromide, sodium lauryl sulphate, Triton X-100, Tween (polysorbate) 20, Tween (polysorbate) 60 and Tween (polysorbate) 80.

In an exemplary method, the surfactant may be added to the homogenized mixture and the homogenized mixture may be subjected to a low-speed homogenization at mixing speeds below 10000 rpm, optionally between 200 rpm and 10000 rpm, before inserting the homogenized mixture into the mold.

In an exemplary method, the nanoparticles may be dispersed or dissolved in a quantity of the matrix material or precursor material that is smaller than the quantity needed for manufacturing the optical filter (bulk material) to generate a concentrate which is then added to the bulk material. In this way, the homogenizing can be promoted.

An exemplary method may further include: dissolving the nanoparticles in a solvent miscible with the liquid matrix material or the liquid precursor of an optically transparent matrix material to obtain a first pre-mixture; adding the first pre-mixture to a liquid optically transparent matrix material or to a liquid precursor of an optically transparent matrix material to obtain a second pre-mixture; and heating the second pre-mixture to a temperature above a boiling point of the solvent and below a boiling or decomposition temperature of the optically transparent matrix material or the precursor of an optically transparent matrix material to obtain a liquid mixture. This can improve the homogeneity of the mixture and reduce or control nanoparticle aggregation.

The optically transparent matrix material or the precursor of an optically transparent matrix material may include: a thermoplastic polymer, a thermosetting polymer, a resin precursor, or mixtures thereof.

The method may further include a mechanical treatment of the filter after removing the filter from the mold and/or applying a coating onto one or more surfaces of the filter, e.g. a protective and/or anti-reflective coating.

In the case of filters comprising a single layer, the filters may be cast as the finished product. They may also be cast as thicker semi-finished filters or lenses which are then, following casting and annealing, formed into the finished product through a combination of cutting, grinding and polishing. Coatings such as a hard-protective coating or other coloring, anti-reflective, anti-ultraviolet or anti-polarization coating may be applied.

In the case of multilayer filters, the filter layers may be successively manufactured in a suitable mold, wherein a particular filter layer is manufactured on top of an already cured or semi-cured filter layer. Prior to the manufacturing of a filter layer on a surface of an already cured or semi-cured filter layer in the mold, the surface of the cured or semi-cured filter layer may be mechanically and/or chemically treated, e.g. abraded, to increase the surface area for enhancing the adhesion between filter layers. The appropriate surface treatment and degree of curing is chosen depending upon the materials in contact with one another and the balance between obtaining the optimal degree of adhesion between successive filter layers and the risk of them reacting with one another in their uncured or semi-cured phases.

Alternatively, or additionally, the surface of the already cured or semi-cured filter layer may be coated with a thin layer of adhesive or uncured resin, provided this does not significantly impede filter clarity or the quality of the viewed image through the filter.

To ensure complete curing and strong adhesion between the filter layers, this thin layer of adhesive or uncured resin may contain one or more polymerization free radical initiators or catalysts that are the same as or different to those found within one or both of the bulk filter materials with which it is in contact.

In the case of multilayer filters comprising at least two filter layers with mutually different dimensions and/or shapes in a direction orthogonal to the thickness direction, the finished product is obtained through a combination of cutting, grinding and polishing that removes the full thickness of one or more layers in one or more places on one or both of the main surfaces of the filter.

### BRIEF DESCRIPTION OF THE DRAWINGS

In the following description, various embodiments of the invention will be described with reference to the accompanying drawings, in which:

FIG. 1 is a schematic drawing of an exemplary optical filter according to the present disclosure.

FIG. 2 shows the transmittance in the wavelength range of 350-800 nm of several exemplary optical filters according to the present disclosure including nanoparticles in mutually different concentrations.

FIG. 3 shows the transmittance in the wavelength range of 350-800 nm of three optical filters according to the present disclosure. All three optical filters comprise the same matrix material and the same type and concentration of nanoparticles, but are of different thicknesses.

FIG. 4 is a schematic drawing of another exemplary optical filter according to the present disclosure.

FIG. 5 is a schematic drawing of an exemplary multilayer optical filter according to the present disclosure.

FIG. 6 is a schematic drawing of another exemplary multilayer optical filter according to the present disclosure.

FIG. 7 is a schematic drawing of yet another exemplary multilayer optical filter according to the present disclosure.

FIG. 8 is a flowchart of an exemplary method of manufacturing an optical filter according to the present disclosure.

FIG. 9 is a flowchart of an exemplary method of generating a liquid mixture according to the present disclosure.

### DETAILED DESCRIPTION

The following detailed description refers to the accompanying drawings that show, by way of illustration, specific details and embodiments in which the invention may be practiced.

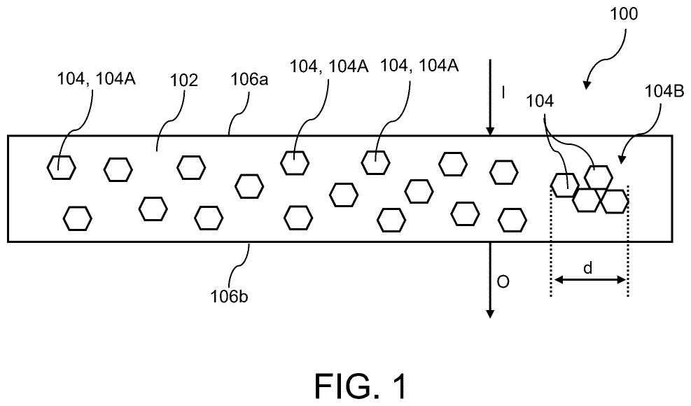

FIG. 1 is a schematic drawing of an exemplary optical filter 100 according to the present disclosure. The filter 100 comprises a matrix 102 including an optically transparent matrix material, and nanoparticles 104 embedded in the matrix material 102. The nanoparticles 104 include carbon atoms arranged in a hexagonal structure.

As indicated in FIG. 1, at least one of the nanoparticles 104A may be physically separated from any other nanoparticle 104, i.e. the at least one nanoparticle 104A may be in exclusive contact with the matrix material, but not with another one of the nanoparticles 104. The existence of such a nanoparticle is an indicator of the homogeneous distribution of the nanoparticles 104 within the matrix material which contributes to reducing or even eliminating undesirable distortions, dimming, or color change as compared to commercially available materials.

As further indicated in FIG. 1, a plurality of the nanoparticles 104 or most of the nanoparticles 104 may be respectively physically separated from any of the other nanoparticles 104.

Some of the nanoparticles 104 may form at least one nanoparticle aggregate 104B including a plurality of the nanoparticles 104. The nanoparticles 104 forming the at least one nanoparticle aggregate 104B are each in physical contact with at least another one of the nanoparticles 104 forming the at least one nanoparticle aggregate 104B.

The at least one nanoparticle aggregate 104B may have a maximum diameter d of less than 30 nm. The existence of such aggregates is a further indicator of a homogeneous distribution of the nanoparticles 104 within the matrix material which contributes to reducing or even eliminating undesirable distortions, dimming, or color change as compared to commercially available materials.

The optical filter 100 may cause a maximum variation of refractive index of ±50-10⁻⁶ and/or may have a maximum density of striae causing an optical path difference of 30 nm of 10%.

The interaction of light with the nanoparticles 104 of the filter 100 reduces or eliminates undesirable wavelengths in the wavelength range of 200 to 600 nm with little distortions, dimming, or color change.

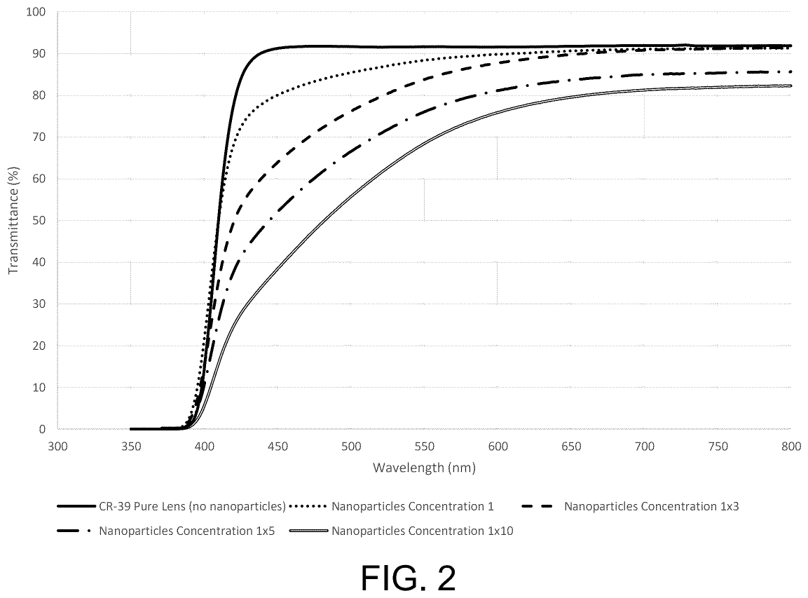

The effect of exemplary filters according to the present disclosure on incident light in the wavelength range of 350 to 800 nm is shown in FIG. 2. The transmittance curve indicated by the solid line is the transmission curve of a first optical filter including a CR-39 matrix material but no nanoparticles embedded in the matrix material. The transmittance curve indicated by the dotted line is the transmittance curve of a second optical filter differing from the first optical filter only in that it comprises nanoparticles of a first concentration embedded in the matrix material. The transmittance curve indicated by the dashed line is the transmittance curve of a third optical filter differing from the second optical filter only in the nanoparticle concentration which is three times the first concentration. The transmittance curve indicated by the dashed-dotted line is the transmittance curve of a fourth optical filter differing from the second optical filter only in the nanoparticle concentration which is five times the first concentration. The transmittance curve indicated by the double line is the transmittance curve of a fifth optical filter differing from the second optical filter only in the nanoparticle concentration which is ten times the first concentration.

FIG. 2 shows that by means of nanoparticles the transmittance of the respective filters in the wavelength range of about 400 to 600 nm is suppressed, i.e. the undesirable wavelength in the blue wavelength range can be suppressed by means of a filter according to the present disclosure. FIG. 2 further shows that this effect increases with nanoparticle concentration.

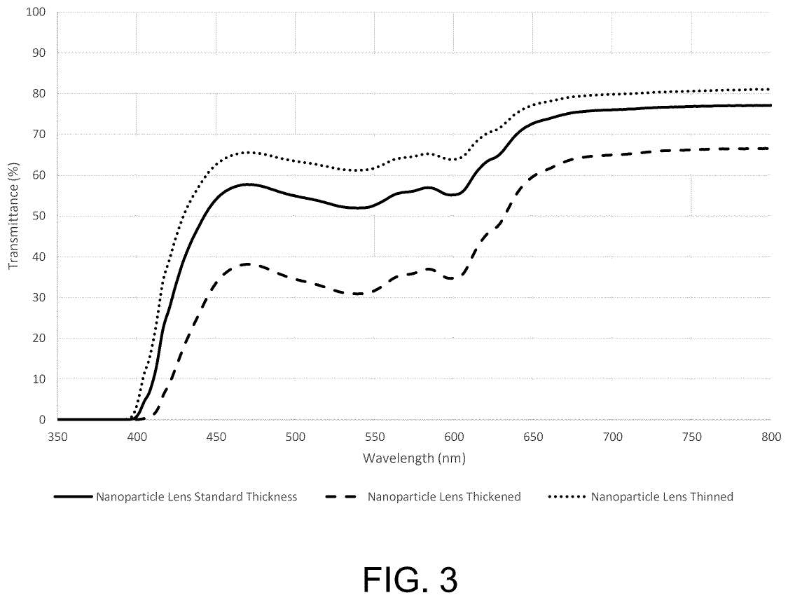

The transmittance in the above wavelength range of 350 to 800 nm can be further controlled by means of the thickness of the optical filter, since the transmittance of the optical filter decreases with increasing thickness. This effect is exemplarily shown in FIG. 3. FIG. 3 shows the transmittance in the wavelength range of 350-800 nm of three optical filters according to the present disclosure. All three optical filters comprise the same matrix material and the same type and concentration of nanoparticles, but are of different thicknesses.

The transmittance curve indicated by the solid line in FIG. 3 is the transmittance curve of one of these optical filters serving as a reference filter. Its thickness is referred to in FIG. 3 as a “Nanoparticle Lens Standard Thickness”. The transmittance curve indicated by the dotted curve in FIG. 3 is the transmittance curve of a first comparative optical filter whose thickness is reduced as compared to the reference filter. The transmittance curve indicated by the dashed curve in FIG. 3 is the transmittance curve of a second comparative optical filter whose thickness is increased as compared to the reference filter.

As can clearly be seen from FIG. 3, the transmittance of optical filters according to the present disclosure decreases with increasing filter thickness in the entire wavelength range of 350-800 nm.

The above-defined maximum variation of refractive index defines the optical inhomogeneity according to Standard ISO 10110-4. A maximum variation of refractive index of ±50·10⁻⁶ as defined above corresponds to Homogeneity Class 0 according to Standard ISO 10110-4. The optical filter 100 may cause a maximum variation of refractive index of ±20·10⁻⁶ (Homogeneity Class 1 according to Standard ISO 10110-4), optionally a maximum variation of refractive index of ±5·10⁻⁶ (Homogeneity Class 2 according to Standard ISO 10110-4), further optionally a maximum variation of refractive index of ±2·10⁻⁶ (Homogeneity Class 3 according to Standard ISO 10110-4), further optionally a maximum variation of refractive index of ±1·10⁻⁶ (Homogeneity Class 4 according to Standard ISO 10110-4), further optionally a maximum variation of refractive index of ±0.5·10⁻⁶ (Homogeneity Class 5 according to Standard ISO 10110-4).

The above-defined maximum density of striae causing an optical path difference of 30 nm of 10% corresponds to Striae Class 1 according to Standard ISO 10110-4. The optical filter 100 may have a maximum density of striae causing an optical path difference of 30 nm of 5% (Striae Class 2 according to Standard ISO 10110-4), optionally a maximum density of striae causing an optical path difference of 30 nm of 2% (Striae Class 3 according to Standard ISO 10110-4), further optionally a maximum density of striae causing an optical path difference of 30 nm of 1% (Striae Class 4 according to Standard ISO 10110-4), further optionally no visible striae (Striae Class 5 according to Standard ISO 10110-4).

A commonly used technique of determining the homogeneity and striae classes is the shadowgraph technique which allows a quantitative assessment of the homogeneity and striae classes by means of a caliper and a reference filter. Alternatively, the homogeneity and striae classes can be determined by means of an interferometer. These techniques are well-known to a skilled person.

Alternatively or additionally, the optical filters according to the present disclosure may be characterized according to one or more of the following standards: ANSI Z80.1, ANSI Z80.3, ISO 8980-1. An optical filter according to an exemplary embodiment of the present disclosure would be capable of satisfying the lens quality and clarity requirements specified in the aforementioned standards.

The nanoparticles 104 may be of diameters (e.g. average diameters corresponding to an arithmetic mean) between 1 nm and 1000 nm. The nanoparticles 104 may be of uniform or random size distribution. They may form aggregates that are larger than individual nanoparticles. The nanoparticles 104 and/or their aggregates may be spherical or rod-shaped, with or without regular or crystalline structure. Depending upon the compositions of both the nanoparticles 104 and the matrix material they may constitute between 0.0005 wt % and 15 wt %, optionally between 0.01 wt % and 5 wt %, of the entire mass of the optical filter 100.

The nanoparticles 100 may include one or both of graphene nanoparticles and carbon nanotubes. Graphene nanoparticles may include or may be fragments of a graphene sheet. The graphene nanoparticles may exist as single, straight sheets, or in a multi-layered or otherwise entangled or wrinkled arrangement. The carbon nanotubes may exist as single-walled or multi-walled nanotubes. The carbon nanotubes may have dimensions (e.g. lengths) between 10 nm and 20 μm, optionally between 20 nm and 5 μm.

The nanoparticles 104 may include nanoparticles including carbon atoms arranged in a pentagonal structure. Nanoparticles of this type can be said to have a mixed hexagonal and pentagonal structure. Such nanoparticles may include or may be configured as fullerenes. The fullerenes may be individual molecules between 1 nm and 10 nm, optionally between 1 nm and 2 nm, in diameter (e.g. average diameter corresponding to an arithmetic mean). The fullerenes may include or may be configured as C₆₀ fullerenes (Buckminster fullerenes) or as higher molecular weight fullerenes such as C₇₀, C₈₄, etc. C₆₀ is composed of 60 carbon atoms ordered in 12 pentagons and 20 hexagons and defining a carbon complex structure (carbon cage).

The nanoparticles 104 may be of the same type or may be mixtures of different types. In the optical filter 100, smaller fullerenes such as C₆₀ and C₇₀ may constitute between 25 wt % and 100 wt %, optionally or preferably between 50 wt % and 95 wt %, of the nanoparticles' total mass (weight).

The fullerenes may include or may be configured as endohedral fullerenes. Endohedral fullerenes are fullerenes that have one or more additional particles (e.g. atoms, ions, molecules) enclosed within the carbon cage. The particles enclosed within the carbon cage are referred to as dopants.

Encasing particles within a fullerene carbon cage is an effective means of combining otherwise incompatible materials within a single optical filter (i.e. materials that may react, disrupt or interfere with one another chemically, optically or mechanically when in direct contact or mixture with one another) as encasement within the fullerene carbon cage prevents the enclosed particles from interacting with one another, and can protect the matrix material from interacting with the enclosed particles that might have good optical properties but degradative chemical or mechanical properties on the matrix material. In contrast to “incompatible materials” “compatible materials” can coexist within the same matrix material and concurrently exhibit their own optical or light-altering effects without negatively affecting one another.

The endohedral fullerenes may contain within their carbon complex structure, i.e. carbon cage, one or more of metal dopants, semimetal dopants, or their respective oxides, chlorides, fluorides, iodides, or nitrates. Exemplary dopants include one or more of: aluminum, antimony, barium, cerium, copper, didymium, gold, iron, lead, magnesium, molybdenum, neodymium, nickel, niobium, palladium, platinum, potassium, praseodymium, silicon, silver, tin, titanium, tungsten, vanadium, zinc and zirconium, as well as their respective oxides, chlorides, fluorides, iodides and/or nitrates.

An effective combination of incompatible particles can be ensured by a mass fraction of the endohedral fullerenes relative to the total mass (weight) of the nanoparticles of 0% to 70 wt %, optionally 20 to 60 wt %, further optionally 30 to 50 wt %.

One or more of the nanoparticles 104 may include one or more functional groups. Nanoparticles including one or more functional groups will be referred to as functionalized nanoparticles. The one or more functional groups may contain elements other than carbon. The functional groups may enhance or alter the interaction of the nanoparticles 104 with light, or may facilitate superior bonding, dissolution or interaction of the nanoparticles 100 with the matrix material.

The one or more functional groups may be or may include one or more of: amide, amine, carbonyl, carboxyl, epoxide, ester, halide, hydroxyl, isocyanate, isothiocyanate, thiol, and sulfur containing groups, e.g. sulphate, sulfone, sulphide groups etc.

The functionalized nanoparticles are functionalized derivatives of the nanoparticles 104. The functionalized derivatives may all contain one or more of the aforementioned functional groups, or there may be a mixture of nanoparticles and their functionalized derivatives with and without the aforementioned functional groups, with the same or different numbers of functional groups. The aforementioned functional groups may be of the same type or may be of different types, e.g. mixtures of different compounds.

The matrix material may include one or more of: an acrylate-based polymer, a polycarbonate-based polymer, a urethane-based polymer, a thiourethane-based polymer, an epoxy-based polymer, and an episulphide-based polymer. An exemplary matrix material may include polymers exhibiting aromatic structure.

The matrix material may comprise a single material type, or may comprise two or more material types, either copolymerized together or simply mixed. In the case where two or more materials are combined in a single optical filter, it is particularly preferred that they be thoroughly mixed so as to give a homogenous final structure to ensure optical and structural consistency across the optical filter 100.

The matrix material may include an inorganic material, optionally an inorganic glass or mineral material. A mass fraction of the inorganic material relative to the entire mass of the matrix material may be at least 50 wt %, optionally at least 80 wt %, further optionally at least 95 wt %.

The optical filter 100 shown in FIG. 1 has two substantially planar main surfaces 106a and 106b opposite to each other. In operation, the filter 100 is positioned such that one of the main surfaces 106a acts as a light input surface and the other one of the main surfaces 106b acts as a light output surface. The light propagation direction is indicated in FIG. 1 by the arrows labelled I and O. Arrow I indicates the direction of light incident onto the light input surface 106a and arrow O indicates the direction of light output from the light output surface 106b.

Due to the substantially planar main surfaces 106a and 106b, the filter 100 does not have refractive power. This means in particular that any of the main surfaces 106a, 106b may act as a light input surface or light output surface.

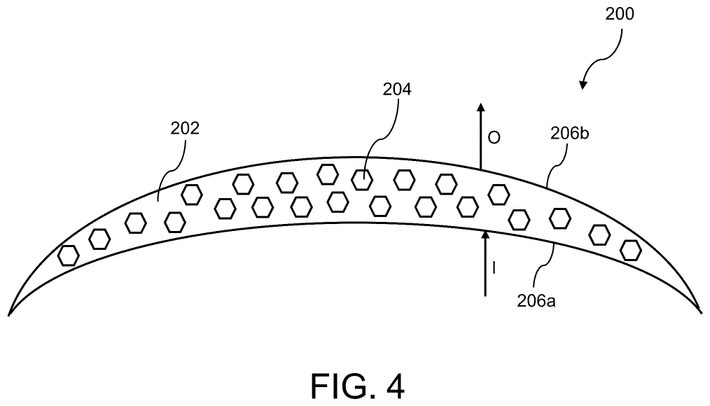

FIG. 4 is a schematic drawing of an optical filter 200 according to another embodiment according to the present disclosure. The optical filter 200 differs from the optical filter 100 shown in FIG. 1 only in view of its shape. More specifically, different from the filter 100 shown in FIG. 1, the filter 200 has two curved main surfaces 206a and 206b. Due to the curved configuration of the main surfaces 206a and 206b and their different degrees of curvature, with the outer surface 206b exhibiting a greater degree of curvature than inner surface 206a, the optical filter 200 has a positive refractive power (dioptre). It is noted that an optical filter with a negative refractive power is also encompassed by the present disclosure.

In FIG. 4, the concave main surface 206a is exemplarily shown as a light input surface for incident light propagating along direction I, and the convex main surface 206b is exemplarily shown as a light output surface. The propagation direction of light having passed through the optical filter 200 is indicated by the arrow O.

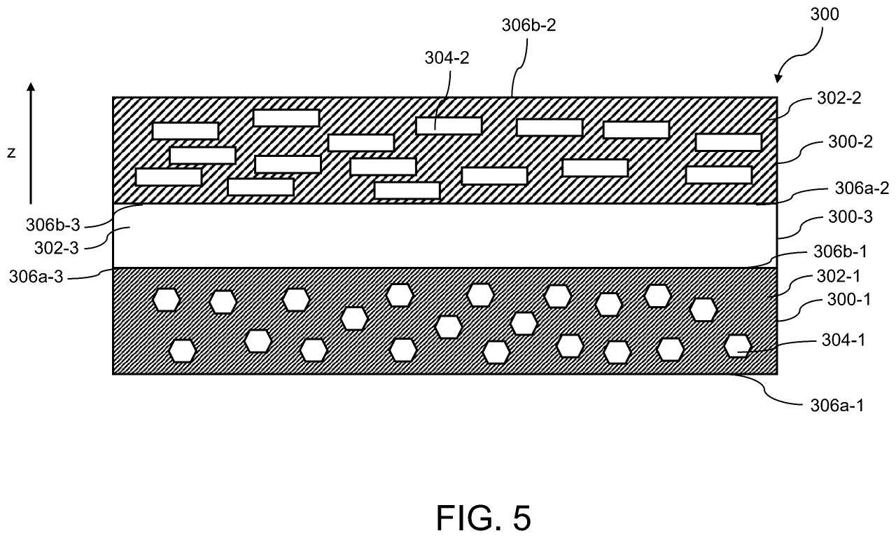

FIG. 5 is a schematic drawing of an exemplary multilayer optical filter 300 comprising a plurality of filter layers 300-1, 300-2, 300-3 stacked in a thickness direction z of the multilayer optical filter 300. The exemplary multilayer filter 300 shown in FIG. 5 includes a first filter layer 300-1, a second filter layer 300-2, and a third filter layer 300-3 sandwiched in the thickness direction z between the first filter layer 300-1 and the second filter layer 300-2.

The first filter layer 300-1 and the second filter layer 300-2 may each be configured as an optical filter described above.

The first filter layer 300-1 may include a first matrix 302-1 including a first optically transparent matrix material, and first nanoparticles 304-1 embedded in the matrix material, the first nanoparticles 304-1 comprising carbon atoms arranged in a hexagonal structure. In FIG. 5, the first nanoparticles 304-1 are exemplarily shown as separated from each other. Additionally or alternatively, the first filter layer 300-1 may include at least one nanoparticle aggregate with a maximum diameter of less than 30 nm.

The first filter layer 300-1 may cause a maximum variation of refractive index of ±50·10⁻⁶ and/or may have a maximum density of striae causing an optical path difference of 30 nm of 10%.

Similarly, the second filter layer 300-2 may include a second matrix 302-2 including a second optically transparent matrix material, and second nanoparticles 304-2 embedded in the second optically transparent matrix material, the second nanoparticles 304-2 comprising carbon atoms arranged in a hexagonal structure. In FIG. 5, the second nanoparticles 304-2 are exemplarily shown as separated from each other. Additionally or alternatively, the second filter layer 300-2 may include at least one nanoparticle aggregate with a maximum diameter of less than 30 nm.

The second layer 300-2 may cause a maximum variation of refractive index of ±50·10⁻⁶ and/or may have a maximum density of striae causing an optical path difference of 30 nm of 10%.

The third filter layer 300-3 may include a third matrix 302-3 including an optically transparent matrix material. The third filter layer 300-3 may be free of nanoparticles including carbon atoms arranged in a hexagonal structure.

The multilayer optical filter 300 shown in FIG. 5 may be of particular interest when using a plurality of incompatible materials. By separating incompatible materials into separate filter layers their benefits can be harnessed without the consequences of their incompatibility. For example, the first optically transparent matrix material included in the first matrix 302-1 may be different from the second optically transparent matrix material included in the second matrix 302-2. Alternatively, or additionally, the first nanoparticles 304-1 may be different from the second nanoparticles 304-2. This configuration offers an effective way of incorporating incompatible matrix materials and/or nanoparticles into a single filter.

The number of filter layers may be different from 3 and may range between 2 and 20, optionally between 2 and 10, further optionally between 2 and 5.

The multilayer optical filter 300 as a whole may cause a maximum variation of refractive index of ±50·10⁻⁶, optionally of ±20·10⁻⁶, further optionally of ±5·10⁻⁶, further optionally of ±2·10⁻⁶, further optionally of ±1·10⁻⁶, further optionally of 0.5·10⁻⁶. Additionally or alternatively, the multilayer optical filter 300 as a whole may have a maximum density of striae causing an optical path difference of 30 nm of 10%, optionally may have a maximum density of striae causing an optical path difference of 30 nm of 5%, further optionally may have a maximum density of striae causing an optical path difference of 30 nm of 2%, further optionally may have a maximum density of striae causing an optical path difference of 30 nm of 1%, further optionally may have no visible striae.

The filter layers 300-1, 300-2, 300-3 may be of the same thickness or may be of different thicknesses depending on the filter characteristics of the filter 300, since the transmittance of a filter is directly linked with its thickness, as discussed above.

The filter layers 300-1, 300-2, 300-2 of the exemplary filter 300 shown in FIG. 5 may each be configured with planar main surfaces 306a-1, 306b-1, 306a-2, 306b-2, 306a-3, 306b-3. Thus, the multilayer filter 300 shown in FIG. 5 does not have refractive power (dioptre).

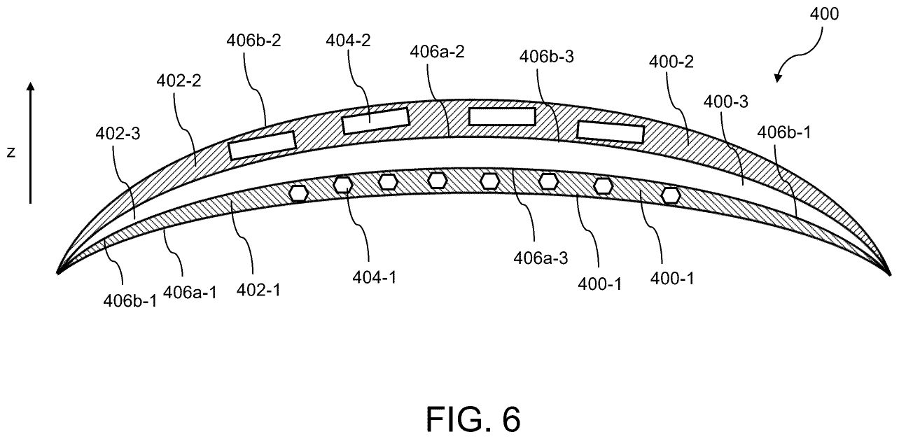

The filter layers may alternatively have refractive power, as exemplarily shown in FIG. 6. The filter 400 shown in FIG. 6 includes a first filter layer 400-1, a second filter layer 400-2, and a third filter layer 400-3 sandwiched in a thickness direction z of the filter 400 between the first filter layer 400-1 and the second filter layer 400-2.

The first filter layer 400-1 and the second filter layer 400-2 may each be configured as an optical filter described above. That is, the first filter layer 400-1 may include a first matrix 402-1 including a first optically transparent matrix material, and first nanoparticles 404-1 embedded in the first matrix material, the first nanoparticles 404-1 comprising carbon atoms arranged in a hexagonal structure.

The first filter layer 400-1 may cause a maximum variation of refractive index of ±50·10⁻⁶ and/or may have a maximum density of striae causing an optical path difference of 30 nm of 10%.

Similarly, the second filter layer 400-2 may include a second matrix 402-2 including a second optically transparent matrix material, and second nanoparticles 404-2 embedded in the second optically transparent matrix material, the second nanoparticles 404-2 comprising carbon atoms arranged in a hexagonal structure. The second filter layer 400-2 may cause a maximum variation of refractive index of ±50·10-6 and/or may have a maximum density of striae causing an optical path difference of 30 nm of 10%.

The third filter layer 400-3 may include a third matrix 402-3 including an optically transparent matrix material. The third filter layer 400-3 may be free of nanoparticles including carbon atoms arranged in a hexagonal structure.

Different from the filter 300 shown in FIG. 5, the filter layers 400-1, 400-2, 400-3 may have curved main surfaces 406a-1, 406b-1, 406a-2, 406b-2, 406a-3, 406b-3 and thus refractive power. Hence, the filter 400 as a whole may have refractive power (dioptre). The filter layers 400-1, 400-2, 400-3 may have the same degree of curvature and refractive power (dioptre) or may have different degrees of curvature and refractive powers depending upon desired mechanical and optical characteristics, as it is desirable to prepare as much as possible of a dioptric lens from the layer with the highest refractive index to reduce overall lens thickness and weight. The thicknesses of the different filter layers 400-1, 400-2, 400-3, as well as the ratios of the thicknesses of the different filter layers 400-1, 400-2, 400-3, may be different in different areas of the filter 400.

As set forth above, each of the above filters 300, 400 may have a filter layer free of nanoparticles comprising carbon atoms arranged in a hexagonal structure. In the filter 300, the third filter layer 300-3 is shown without nanoparticles comprising carbon atoms arranged in a hexagonal structure. In the filter 400 the third filter layer 400-3 is shown without nanoparticles comprising carbon atoms arranged in a hexagonal structure. These filter layers 300-3, 400-3 may effectively separate the adjacent filter layers 300-1, 300-2 and 400-1, 400-2, respectively. Hence these adjacent filter layers may include mutually incompatible nanoparticles and/or mutually incompatible matrix materials.

The filter layers 300-3, 400-3 that are free of nanoparticles comprising carbon atoms arranged in a hexagonal structure may include an inorganic material, optionally an inorganic glass or mineral material with a mass fraction relative to the total mass (weight) of the respective filter layers 300-2, 400-3 of at least 50 wt %, optionally at least 80 wt %, further optionally at least 95 wt %.

As set forth above, the mineral or inorganic glass containing filter layers 300-3, 400-3 are sandwiched in the thickness direction z between the other filter layers 300-1 and 300-2 or 400-1 and 400-2 which, hence, may act as protection layers for the inorganic glass or mineral containing layers 300-3, 400-3.

In an exemplary multilayer filter including a plurality of mineral or inorganic glass containing filter layers, at least two of the plurality of these layers may be separated by at least one polymer or resin layer to prevent glass-on-glass contact and abrasion and/or fracture.

The mineral or inorganic glass may be enriched with a metal or semimetal, or its respective oxide for enhancing its optical or mechanical properties. Although there is no particular limitation, the most preferable metals and semimetals include one or more of: aluminium, barium, boron, calcium, cerium, didymium, gold, lead, magnesium, neodymium, niobium, platinum, potassium, praseodymium, silver, sodium, strontium, tin, titanium and zirconium, as well as their respective oxides.

The filter layers 300-3, 400-3 that are free of nanoparticles comprising carbon atoms arranged in a hexagonal structure may contain a single enriching compound, or may contain multiple enriching compounds to harness the enhancing properties of multiple compounds within a single layer. In the case of optical filters comprising a plurality of inorganic glass or mineral containing filter layers that are free of nanoparticles comprising carbon atoms arranged in a hexagonal structure, the layers may comprise the same inorganic glass or mineral, or different inorganic glass or mineral materials, mixtures or combinations thereof, so as to harness the optical qualities of multiple different materials within a single optical filter. These layers may contain the same enriching compound or combination of enriching compounds, or may contain different enriching compounds or combinations therein. A given glass or mineral filter layer may contain one or more enriching agents. The enriching agent or agents may constitute between 0.5 wt % to 70 wt %, preferably 5 wt % and 40 wt %, of the entire mass of the respective inorganic glass or mineral containing filter layer.

In the exemplary multilayer filter 300 shown in FIG. 5, the filter layers 300-1, 300-2, 300-3 may have substantially the same dimensions and/or shapes in a direction orthogonal to the thickness direction z. This basically also applies to the filter 400 shown in FIG. 6. In these multilayer filters 300, 400, a light beam passes through a substantially equal number of filter layers independent of the incident angle and location on the filter 300, 400 and offers, hence, a consistent image across the multilayer filter 300, 400. Such a configuration is particularly suitable for multilayer filters configured as plano or single-dioptre lenses.

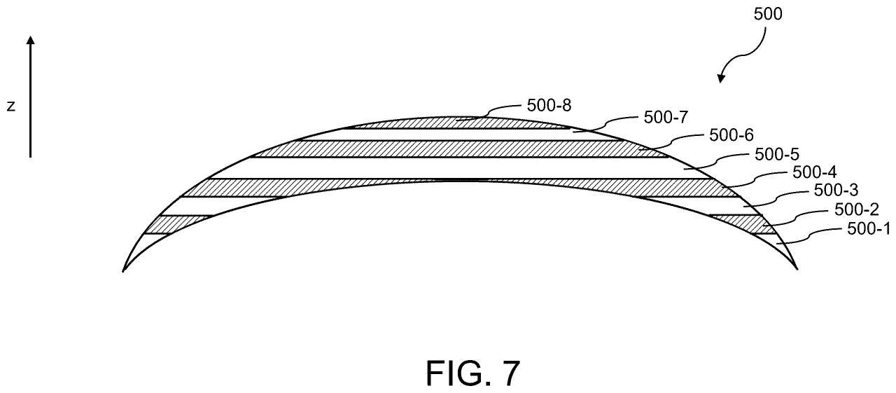

FIG. 7 shows an exemplary multilayer filter 500 including a plurality of filter layers 500-1, 500-2, 500-3, 500-4, 500-5, 500-6, 500-7, 500-8 stacked in a thickness direction z of the filter 500. The filter layers 500-2, 500-4, 500-6, 500-8 indicated by the hatched areas in FIG. 7 may include nanoparticles including carbon atoms arranged in a hexagonal structure. As shown in FIG. 7, the filter layers 500-1, 500-2, 500-3, 500-4, 500-5, 500-6, 500-7 and 500-8 have mutually different dimensions or mutually different shapes or mutually different dimensions and shapes in a direction orthogonal to the thickness direction z. In such a multilayer filter, a light beam passes through a variable number of filter layers depending on the incident angle and location on the filter. Such a configuration is particularly suitable for progressive ophthalmic lenses or light filters for medical or technical uses, as the refractive power and/or intensity of transmitted light may be different in different parts of the filter.

The above-described optical filters 100, 200 or multilayer optical filters 300, 400, 500 may be used as a protective screen on top of or incorporated into the screen of an electronic device (such as televisions, mobile phones etc.). Alternatively, these filters may be used in eyeglasses or sunglasses, or may be used as lenses for technical applications (such as in cameras, binoculars, telescopes, lamps etc.).

The optical filters 100, 200 and/or the filter layers 300, 400, 500 described above may further include other particles that confer certain unique optical properties, e.g. altering the refractive index. These other particles may comprise metals or semimetals or their respective oxides, chlorides, fluorides, iodides or nitrates. Although there is no particular limitation, the most preferable metals and semimetals are aluminium, antimony, barium, cerium, copper, didymium, gold, iron, lead, magnesium, molybdenum, neodymium, nickel, niobium, palladium, platinum, potassium, praseodymium, silicon, silver, tin, titanium, tungsten, vanadium, zinc and zirconium, as well as their oxides, chlorides, fluorides, iodides and nitrates. These other particles may all be of the same type, i.e. the same material, or may be a mixture of different materials. These other particles may be between 2 nm and 5 μm in diameter (e.g. average diameter corresponding to an arithmetic mean), but are most preferably between 5 nm and 3 μm. They may all be of the same diameter, or may be of different diameters. These other particles comprising one or more of the aforementioned compounds may constitute between 0 wt % and 80 wt %, preferably between 5 wt % and 50 wt %, of the nanoparticles' total mass.

The optical filters 100, 200, 300, 400, 500 described above may further include one or more of: dyes (which may or may not have their own light filtering effect), ultraviolet inhibitors, mold release agents etc. Such additional components may also be added to filter layers that do not contain the nanoparticles comprising carbon atoms arranged in a hexagonal structure. They may be dissolved in the matrix material to a molecular level, and may be partially-dissolved or fully-dissolved. Alternatively, the nanoparticles and/or the other particles may exist in the matrix as clusters or aggregates, depending on their composition, method of introduction into the matrix material and desired optical qualities. Individual clusters or aggregates may be homogenous or may be mixtures of different nanoparticle/particle types. These clusters or aggregates may exhibit regular, ordered structure or irregular, random structure and may be spherical, rod-shaped, amorphous or crystalline, depending on their composition, method of preparation and desired optical qualities. Within a given optical filter or optical filter layer some of the other particles may exist as individual particles and some may exist concurrently as clusters or aggregates.

Further, nanoparticles may, through controlled settling or flotation, form a visually-distinctive layer of their own, but are most preferably homogenously-distributed throughout the matrix material.

The other particles may be dispersed in the matrix to a degree such that individual particles are exclusively surrounded by and in contact with the matrix material.

Each of the above-described filters 100, 200, 300, 400, 500, as a whole object, may further include an outer coating. Although there is no particular limitation, the most preferable coatings are hard protective coatings or other coloring, anti-reflective, anti-ultraviolet or anti-polarization coatings, as is well known in the art.

In addition, the filter layers 300-1, 300-2, 300-3, 400-1, 400-2, 400-3, 500-1, . . . , 500-8 described above may be separated by a thin coating or adhesive, or may be directly layered on top of one another, depending on the desired mechanical and optical properties.

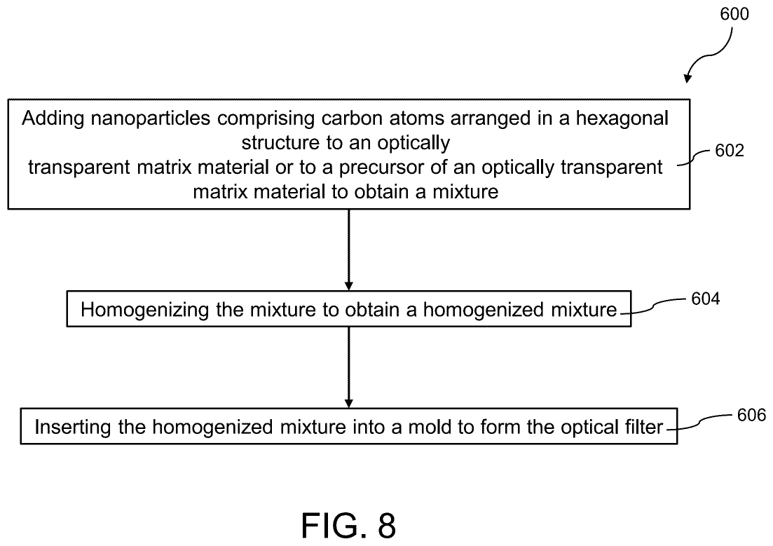

FIG. 8 is a flowchart of an exemplary method 600 of manufacturing an optical filter according to the present disclosure. The method 600 may include: adding nanoparticles comprising carbon atoms arranged in a hexagonal structure to an optically transparent matrix material or to a precursor of an optically transparent matrix material to obtain a mixture 602; homogenizing the mixture to obtain a homogenized mixture 604; and inserting the homogenized mixture into a mold to form the optical filter 606. This method 600 may be carried out in the above-described order. Any of the above-described nanoparticles and/or matrix materials described in the context of the above-described filters 100-500 may be used for manufacturing an optical filter by means of this method 600.

The homogenizing the mixture overcomes the nanoparticles' extremely limited solubility and problems with excessive or uncontrolled clustering or aggregations, which result in low-quality, unclear lenses. The above method 600 thus enables the manufacturing of optical filters and multilayer filters with the above-described properties.

The nanoparticles extremely limited solubility necessitates their dispersion within the matrix material or precursor material as a colloidal suspension rather than as a solution, which in turn necessitates dispersion and homogenization in place of dissolution. Where dissolution of the nanoparticles is possible or required, their solubility with respect to the optically transparent matrix material or to the precursor of an optically transparent matrix material must be determined. Where colloidal dispersions of nanoparticles within the optically transparent matrix material or to the precursor of an optically transparent matrix material are desired or necessitated with only partial or no dissolution, a critical factor is the rate at which the nanoparticles sediment or float, determined by the following equation, which assumes that the nanoparticles are spherical:

$${Υ}_{s} = \frac{V ( {ρ}_{p} - {ρ}_{m} ) g}{6 π η r}$$

Here, Yₛ is the nanoparticle sedimentation or flotation velocity, V is the nanoparticle volume, ρₚ is the nanoparticle density, ρₘ is the density of the optically transparent matrix material or the precursor of an optically transparent matrix material, g is the gravitational acceleration, η is the viscosity of the optically transparent matrix material or the precursor of an optically transparent matrix material and r is the nanoparticle radius.

The size of the nanoparticles and the difference in density between the nanoparticles and the optically transparent matrix material or the precursor of an optically transparent matrix material determine the rate at which the nanoparticles will float or sink, with smaller particles generally sinking or floating more slowly than their larger counterparts. Sedimentation or flotation velocity is inversely proportional to the viscosity of the optically transparent matrix material or the precursor of an optically transparent matrix material. When balanced against the time that the mixture must stand prior to curing, as well as the curing time and the increase in viscosity induced by the setting or curing of the optically transparent matrix material or the precursor of an optically transparent matrix material, the most appropriate nanoparticle or nanoparticle aggregate diameter can be determined, and the most appropriate point in the filter preparation process can be selected for the introduction of the nanoparticles. In the case where multiple matrix materials are used, the most appropriate individual or combination of these can be selected as the one in which to disperse the nanoparticles.

Without wishing to be bound by any particular theory, the dispersibilities of nanoparticles and their final diameters in colloidal suspensions are heavily influenced by the ability of the fluid to mechanically break up and disperse the nanoparticle material using shear force:

$$τ = {ηΥ}_{m}$$

Here, r is the shear force upon the nanomaterial during mixing, η is the viscosity of the optically transparent matrix material or the precursor of an optically transparent matrix material, and Yₘ is the velocity of the optically transparent matrix material or the precursor of an optically transparent matrix material during mixing. The efficacy of any such mixing and dispersing process is further dictated by the rate of liquid shear:

$${R}_{s} = \frac{{V}_{u}}{{D}_{s}}$$

Here, Rₛ is the shear rate, Vᵤ is the tip speed of the rotor (the spinning unit that mixes the liquid, with Vᵤ itself determined by the rotor's diameter and its number of revolutions per minute), and Dₛ is the distance between the rotor and the stator (the housing around the rotor). This allows for the obtaining of a high shear rate without being constrained by any one single dimension of the apparatus required to achieve it. A high liquid shear force, liquid velocity and shear rate are required to obtain particularly fine nanoparticles and, thus, stable suspensions of nanoparticles within the optically transparent matrix material or the precursor of an optically transparent matrix material. This process can be assisted through the selection of high viscosities of the optically transparent matrix material or the precursor of an optically transparent matrix material.

The homogenizing the mixture may include: a high-speed homogenization at mixing speeds above 5000 rpm (rotations per minute), optionally above 10000 rpm, further optionally between 10000 rpm and 80000 rpm, and/or a sonication at frequencies above 5 kHz, optionally above 10 kHz, further optionally between 10 KHz and 80 KHz. Such a homogenizing of the mixture leads to a colloidal suspension which effectively overcomes the problems resulting from the nanoparticles' extremely limited solubility in commonly used matrix materials or precursors of commonly used matrix materials.

The homogenizing the mixture may involve mixing with shear rates above 30000 s⁻¹, optionally above 50000 s⁻¹, further optionally between 60000 s⁻¹ and 350000 s⁻¹. Mixing with these shear rates contributes to a highly homogeneous distribution of the nanoparticles within the mixture.

The homogenizing can be carried out at temperatures above room temperature and below the melting, boiling, or decomposition temperature of the matrix material or precursor of the matrix material. Alternatively, in case the nanoparticles are added to a precursor of the matrix material, the homogenizing can be carried out at temperatures below room temperature to control the stability and increase the viscosity of the precursor which improves the shearing ability of the precursor.

The mixing may be performed under a vacuum, e.g. at a pressure below 0.1 bar, optionally below 0.01 bar, further optionally below 0.001 bar, to prevent the mixing and dissolution of gases into the mixture, as the presence of gas or bubbles in the material can produce an optically inferior filter. The mixing may be performed under an inert gaseous atmosphere to prevent reaction or oxidation of either the matrix or precursor material or the nanoparticles or additives, which can compromise the filter's optical or mechanical properties. The nanoparticles may be mixed with or added alongside other additives to the filters such as antioxidants, UV stabilizers, dyes and mold-release agents. In cases where multiple types of nanoparticles are added, they may be added at the same time or at different stages in the mixing process depending upon the desired degrees of homogenization for the different nanoparticle types.

During the adding the nanoparticles to the optically transparent matrix material or to the precursor of an optically transparent matrix material the optically transparent matrix material or the precursor of an optically transparent matrix material may be in a liquid state to obtain a liquid mixture and/or during the homogenizing the mixture the mixture may be in a liquid state. By means of these measures, the degree of homogeneity can be further increased. Alternatively, in the case where a thermoplastic is used for or as the matrix material, the nanoparticles may be added to the granular or powdered thermoplastic prior to melting.

The degree of homogeneity can be further increased by adding a surfactant to the liquid mixture or the homogenized mixture. The use of a surfactant may be of particular importance in case where homogenous dispersion of the nanoparticles without dissolution is desired, or a protective layer around the nanoparticles is desired to prevent their direct interaction with the matrix material of the precursor material. This surfactant may be added before, at the same time as or after the nanoparticles, depending upon the type of nanoparticles and their interactions with the surfactant and matrix or precursor material. In instances where high-speed homogenization is utilized the surfactant is most preferably added after homogenization to avoid the generation of excess foam. One or more surfactants may be used, which may be added concurrently or during different phases of the method.

A mass ratio of surfactant to nanoparticles may be in the range of 1:1 to 50:1, optionally of 10:1 to 35:1. Suitable surfactants are surfactants selected from the group consisting of non-ionic surfactants, anionic surfactants, cationic surfactants, and amphoteric surfactants, or mixtures thereof. Although there is no particular limitation, the most preferable surfactants include one or more of dodecyl trimethyl ammonium chloride, myristyl trimethyl ammonium bromide, sodium lauryl sulphate, Triton X-100, Tween (polysorbate) 20, Tween (polysorbate) 60 and Tween (polysorbate) 80.

In an exemplary method, the surfactant may be added to the homogenized mixture and the homogenized mixture may be subjected to a low-speed homogenization at mixing speeds below 10000 rpm, optionally between 200 rpm and 10000 rpm, before inserting the homogenized mixture into the mold.

In an exemplary method, the nanoparticles may be dispersed or dissolved in a quantity of the matrix material or precursor material that is smaller than the quantity needed for manufacturing the optical filter (bulk material) to generate a concentrate which is then added to the bulk material. In this way, the homogenizing can be promoted.

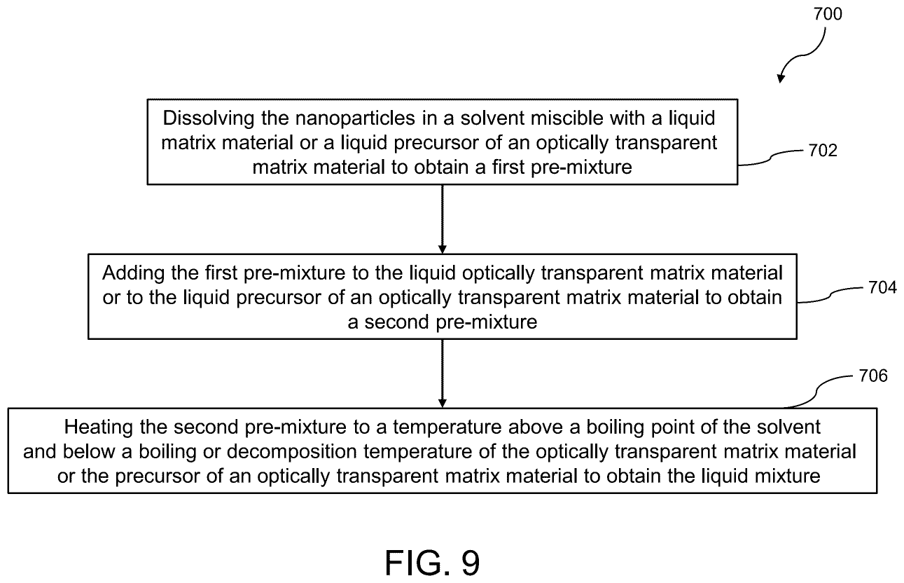

FIG. 9 is a flowchart of an exemplary method 700 of generating a liquid mixture according to an exemplary embodiment. The method 700 may include: dissolving the nanoparticles in a solvent miscible with the liquid matrix material or the liquid precursor of an optically transparent matrix material to obtain a first pre-mixture 702; adding the first pre-mixture to a liquid optically transparent matrix material or to a liquid precursor of an optically transparent matrix material to obtain a second pre-mixture 704; and heating the second pre-mixture to a temperature above a boiling point of the solvent and below a boiling or decomposition temperature of the optically transparent matrix material or the precursor of an optically transparent matrix material to obtain a liquid mixture 706. By means of this method 700, the homogeneity of the mixture can be improved and nanoparticle aggregation can be reduced or controlled.

The optically transparent matrix material or the precursor of an optically transparent matrix material may include: a thermoplastic polymer, a thermosetting polymer, a resin precursor, or mixtures thereof.

The method may further include a mechanical treatment of the filter after removing the filter from the mold and/or applying a coating onto one or more surfaces of the filter, e.g. a protective and/or anti-reflective coating.

In the case of filters comprising a single layer, the filters may be cast as the finished product, whether in plano form or with a dioptre. They may also be cast as thicker semi-finished filters or lenses which are then, following casting and annealing, formed into the finished product through a combination of cutting, grinding and polishing. Coatings such as a hard-protective coating or other coloring, anti-reflective, anti-ultraviolet or anti-polarization coating may be applied.

In the case of multilayer filters, the filter layers may be successively manufactured in a suitable mold, wherein a particular filter layer is manufactured on top, i.e. on a surface, of an already cured or semi-cured filter layer. Prior to the manufacturing of a filter layer on a surface of an already cured or semi-cured filter layer in the mold, the surface of the cured or semi-cured filter layer may be mechanically and/or chemically treated, e.g. abraded, to increase the surface area for enhancing the adhesion between filter layers. The appropriate surface treatment and degree of curing is chosen depending upon the materials in contact with one another and the balance between obtaining the optimal degree of adhesion between successive filter layers and the risk of them reacting with one another in their uncured or semi-cured phases.

Alternatively, or additionally, the surface of the already cured or semi-cured filter layer may be coated with a thin layer of adhesive or uncured resin, provided this does not significantly impede filter clarity or the quality of the viewed image through the filter.

To ensure complete curing and strong adhesion between the filter layers, this thin layer of adhesive or uncured resin may contain one or more polymerization free radical initiators or catalysts that are the same as or different to those found within one or both of the bulk filter materials with which it is in contact.

In the case of multilayer filters, like the filter shown in FIG. 7, comprising at least two filter layers with mutually different dimensions and/or shapes in a direction orthogonal to the thickness direction, in addition to casting the finished product may be obtained through a combination of cutting, grinding and polishing that removes the full thickness of one or more layers in one or more places on one or both of the main surfaces of the filter.

In the following, several Examples according to the present disclosure will be described.

Example 1 is an optical filter, comprising: a matrix including an optically transparent matrix material, and nanoparticles embedded in the matrix material, the nanoparticles comprising carbon atoms arranged in a hexagonal structure. At least one of the nanoparticles may be physically separated from any other of the nanoparticles and/or at least one nanoparticle aggregate including a plurality of the nanoparticles may have a maximum diameter of less than 30 nm, each of the nanoparticles of the at least one nanoparticle aggregate being in physical contact with at least another one of the nanoparticles of the at least one nanoparticle aggregate.

In Example 2, the optical filter of Example 1 can optionally further include that the optical filter causes a maximum variation of refractive index of ±50·10⁻⁶ and/or has a maximum density of striae causing an optical path difference of 30 nm of 10%.

In Example 3, the optical filter according to Example 1 or 2 can optionally further include that the nanoparticles include one or both of graphene nanoparticles and carbon nanotubes.

In Example 4, the optical filter according to any one of Examples 1 to 3 can optionally further include that the nanoparticles include nanoparticles including carbon atoms arranged in a pentagonal structure, optionally fullerenes, further optionally endohedral fullerenes.

In Example 5, the optical filter according to Example 4 can optionally further include that the nanoparticles include endohedral fullerenes containing within their carbon complex structure one or more of metal dopants, semimetal dopants, or their respective oxides, chlorides, fluorides, iodides, or nitrates.

In Example 6, the optical filter according to any one of Examples 1 to 5 can optionally further include that one or more of the nanoparticles include one or more functional groups.

In Example 7, the optical filter according to Example 6 can optionally further include that the one or more functional groups are or include one or more of: amide, amine, carbonyl, carboxyl, epoxide, ester, halide, hydroxyl, isocyanate, isothiocyanate, thiol, and sulfur containing groups.

In Example 8, the optical filter according to any one of Examples 1 to 7 can optionally further include that the matrix material includes one or more of: an acrylate-based polymer, a polycarbonate-based polymer, a urethane-based polymer, a thiourethane-based polymer, an epoxy-based polymer, and an episulphide-based polymer or other polymer or resin exhibiting aromatic structure.

In Example 9, the optical filter according to any one of Examples 1 to 8 can optionally further include that the matrix material includes an inorganic material, optionally an inorganic glass material, in an amount of at least 50 wt %, optionally at least 80 wt %, further optionally at least 95 wt %, based on the total mass of the matrix material.

Example 10 is a multilayer optical filter comprising a plurality of filter layers stacked in a thickness direction of the multilayer optical filter, wherein one or more filter layers of the plurality of filter layers are configured as an optical filter according to any one of Examples 1 to 9.

In Example 11, the multilayer optical filter according to Example 10 can optionally further include that the plurality of filter layers includes first and second filter layers configured as optical filters according to any one of Examples 1 to 9 with mutually different nanoparticle compositions or with mutually different matrix materials or with mutually different nanoparticle compositions and mutually different matrix materials.

In Example 12, the multilayer optical filter according to Example 10 or 11 can optionally further include that at least one filter layer of the plurality of filter layers is free of nanoparticles comprising carbon atoms arranged in a hexagonal structure.

In Example 13, the multilayer optical filter according to Example 12 can optionally further include that the at least one filter layer that is free of nanoparticles comprising carbon atoms arranged in a hexagonal structure includes an inorganic material, optionally an inorganic glass material, in an amount of at least 50 wt %, optionally at least 80 wt %, further optionally at least 95 wt %, based on the total weight of the at least one filter layer.

In Example 14, the multilayer optical filter according to any one of Examples 10 to 13 can optionally further include that at least two filter layers of the plurality of filter layers have mutually different dimensions or mutually different shapes or mutually different dimensions and shapes in a direction orthogonal to the thickness direction.

Example 15 is a method of manufacturing an optical filter, the method comprising: adding nanoparticles comprising carbon atoms arranged in a hexagonal structure to an optically transparent matrix material or to a precursor of an optically transparent matrix material to obtain a mixture; homogenizing the mixture to obtain a homogenized mixture; and inserting the homogenized mixture into a mold to form the optical filter.

In Example 16, the method according to Example 15 can optionally further include that the homogenizing the mixture includes one or both of: a high-speed homogenization at mixing speeds above 5000 rpm, optionally above 10000 rpm, further optionally between 10000 rpm and 80000 rpm, and a sonication at frequencies above 5 kHz, optionally above 10 kHz, further optionally between 10 KHz and 80 KHz.

In Example 17, the method according to Example 15 or 16 can optionally further include that the homogenizing the mixture involves mixing with shear rates above 30000 s⁻¹, optionally above 50000 s⁻¹, further optionally between 60000 s⁻¹ and 350000 s⁻¹.

In Example 18, the method according to any one of Examples 15 to 17 can optionally further include that during the adding the nanoparticles to the optically transparent matrix material or to the precursor of an optically transparent matrix material the optically transparent matrix material or the precursor of an optically transparent matrix material is in a liquid state to obtain a liquid mixture, and/or during the homogenizing the mixture the mixture is in a liquid state.

In Example 19, the method according to Example 18 can optionally further include that a surfactant is added to the liquid mixture or the homogenized mixture.

In Example 20, the method according to Example 19 can optionally further include that a mass ratio of surfactant to nanoparticles is in the range of 1:1 to 50:1, optionally of 10:1 to 35:1.

In Example 21, the method according to Example 19 or 20 can optionally further include that the surfactant is selected from the group consisting of non-ionic surfactants, anionic surfactants, cationic surfactants, and amphoteric surfactants, or mixtures thereof.

In Example 22, the method according to any one of Examples 19 to 21 can optionally further include that the surfactant is added to the homogenized mixture and the homogenized mixture is subjected to a low-speed homogenization at mixing speeds below 10000 rpm, optionally between 200 rpm and 10000 rpm, before inserting the homogenized mixture into the mold.

In Example 23, the method according to any one of Examples 18 to 22 can optionally further include that the nanoparticles are dissolved in a solvent miscible with the liquid matrix material or the liquid precursor of an optically transparent matrix material to obtain a first pre-mixture, the first pre-mixture is added to the liquid optically transparent matrix material or to the liquid precursor of an optically transparent matrix material to obtain a second pre-mixture, and the second pre-mixture is heated to a temperature above a boiling point of the solvent and below a boiling or decomposition temperature of the optically transparent matrix material or the precursor of an optically transparent matrix material to obtain the liquid mixture.

In Example 24, the method according to any one of Examples 15 to 23 can optionally further include that the optically transparent matrix material or the precursor of an optically transparent matrix material includes a thermoplastic polymer, a thermosetting polymer, a resin precursor, or mixtures thereof.

1. An optical filter, comprising:
a matrix including an optically transparent matrix material, and
nanoparticles embedded in the matrix material, the nanoparticles comprising carbon atoms arranged in a hexagonal structure and including one or more of graphene nanoparticles, carbon nanotubes, and fullerenes,
wherein at least one nanoparticle aggregate including a plurality of the nanoparticles has a maximum diameter of less than 30 nm, each of the nanoparticles of the at least one nanoparticle aggregate being in physical contact with at least another one of the nanoparticles of the at least one nanoparticle aggregate.

2. The optical filter of claim 1, wherein a maximum variation of refractive index of the optical filter is ±50·10⁻⁶ and/or the optical filter has a maximum density of striae causing an optical path difference of 30 nm of 10%.

3. The optical filter according to claim 1, wherein the nanoparticles include endohedral fullerenes.

4. The optical filter according to claim 3, wherein the nanoparticles include endohedral fullerenes containing within their carbon complex structure one or more of metal dopants, semimetal dopants, or their respective oxides, chlorides, fluorides, iodides, or nitrates.

5. The optical filter according to claim 1, wherein one or more of the nanoparticles include one or more functional groups.

6. The optical filter according to claim 5, wherein the one or more functional groups are or include one or more of: amide, amine, carbonyl, carboxyl, epoxide, ester, halide, hydroxyl, isocyanate, isothiocyanate, thiol, and sulfur containing groups.

7. The optical filter according to claim 1, wherein the matrix material includes one or more of: an acrylate-based polymer, a polycarbonate-based polymer, a urethane-based polymer, a thiourethane-based polymer, an epoxy-based polymer, and an episulphide-based polymer or other polymer or resin exhibiting aromatic structure.

8. The optical filter according to claim 1, wherein the matrix material includes an inorganic material, optionally an inorganic glass material, in an amount of at least 50 wt %, optionally at least 80 wt %, further optionally at least 95 wt %, based on the total mass of the matrix material.

9. A multilayer optical filter comprising a plurality of filter layers stacked in a thickness direction of the multilayer optical filter, wherein one or more filter layers of the plurality of filter layers are configured as an optical filter according to claim 1.

10. The multilayer optical filter according to claim 9, wherein the plurality of filter layers includes first and second filter layers configured as optical filters according to claim 1 with mutually different nanoparticle compositions or with mutually different matrix materials or with mutually different nanoparticle compositions and mutually different matrix materials.

11. The multilayer optical filter according to claim 9, wherein at least one filter layer of the plurality of filter layers is free of nanoparticles comprising carbon atoms arranged in a hexagonal structure.

12. The multilayer optical filter according to claim 11, wherein the at least one filter layer that is free of nanoparticles comprising carbon atoms arranged in a hexagonal structure includes an inorganic material, optionally an inorganic glass material, in an amount of at least 50 wt %, optionally at least 80 wt %, further optionally at least 95 wt %, based on the total weight of the at least one filter layer.

13. The multilayer optical filter according to claim 9, wherein at least two filter layers of the plurality of filter layers have mutually different dimensions or mutually different shapes or mutually different dimensions and shapes in a direction orthogonal to the thickness direction.

14. A method of manufacturing an optical filter, the method comprising:
adding nanoparticles comprising carbon atoms arranged in a hexagonal structure to an optically transparent matrix material or to a precursor of an optically transparent matrix material to obtain a mixture, the nanoparticles including one or more of graphene nanoparticles, carbon nanotubes, and fullerenes;
homogenizing the mixture to obtain a homogenized mixture, wherein the homogenizing the mixture involves mixing with shear rates between 60000 s⁻¹ and 350000 s⁻¹; and
inserting the homogenized mixture into a mold to form the optical filter.

15. The method according to claim 14, wherein the homogenizing the mixture includes one or both of:
a high-speed homogenization at mixing speeds above 5000 rpm, optionally above 10000 rpm, further optionally between 10000 rpm and 80000 rpm, and
a sonication at frequencies above 5 kHz, optionally above 10 kHz, further optionally between 10 kHz and 80 kHz.

16. The method according to claim 14, wherein
during the adding the nanoparticles to the optically transparent matrix material or to the precursor of an optically transparent matrix material the optically transparent matrix material or the precursor of an optically transparent matrix material is in a liquid state to obtain a liquid mixture, and/or
during the homogenizing the mixture the mixture is in a liquid state.

17. The method according to claim 16, wherein a surfactant is added to the liquid mixture or the homogenized mixture.

18. The method according to claim 17, wherein a mass ratio of surfactant to nanoparticles is in the range of 1:1 to 50:1, optionally of 10:1 to 35:1.

19. The method according to claim 17, wherein the surfactant is selected from the group consisting of non-ionic surfactants, anionic surfactants, cationic surfactants, and amphoteric surfactants, or mixtures thereof.

20. The method according to any one of claim 17, wherein the surfactant is added to the homogenized mixture and the homogenized mixture is subjected to a low-speed homogenization at mixing speeds below 10000 rpm, optionally between 200 rpm and 10000 rpm, before inserting the homogenized mixture into the mold.

21. The method according to claim 16, wherein
the nanoparticles are dissolved in a solvent miscible with the liquid matrix material or the liquid precursor of an optically transparent matrix material to obtain a first pre-mixture,
the first pre-mixture is added to the liquid optically transparent matrix material or to the liquid precursor of an optically transparent matrix material to obtain a second pre-mixture, and
the second pre-mixture is heated to a temperature above a boiling point of the solvent and below a boiling or decomposition temperature of the optically transparent matrix material or the precursor of an optically transparent matrix material to obtain the liquid mixture.

22. The method according to claim 14, wherein
the optically transparent matrix material or the precursor of an optically transparent matrix material includes a thermoplastic polymer, a thermosetting polymer, a resin precursor, or mixtures thereof.
